(19) United States
(12) Patent Application Publication
(10) Pub. No.: US 2024/0015805 A1
(43) Pub. Date: Jan. 11, 2024

(54) BLUETOOTH NETWORK ESTABLISHING SYSTEM AND METHOD

(71) Applicant: Realtek Semiconductor Corporation, Hsinchu (TW)

(72) Inventors: Weifeng MAO, Jiangsu Province (CN); Zhuwei LU, Jiangsu Province (CN); Jidong CHEN, Jiangsu Province (CN); Zuomin LI, Jiangsu Province (CN)

(21) Appl. No.: 18/147,713

(22) Filed: Dec. 29, 2022

(30) Foreign Application Priority Data
Jul. 7, 2022 (CN) 202210847146.4

(51) Int. Cl. H04W 76/10; H04W 40/24

(52) U.S. Cl. CPC H04W 76/10; H04W 40/246

(57) ABSTRACT

A Bluetooth network establishing system and method are provided. The system includes a plurality of node devices and a gateway device. The gateway device is used to connect a Bluetooth network to an external network and broadcast a first connectable undirected advertising packet. A first node device among the node devices executes a first scan operation to receive a first advertising packet, wherein the first advertising packet includes the first connectable undirected advertising packet. The first node device determines whether to establish a first communication connection with the gateway devices to join the Bluetooth network according to the first advertising packet. After joining the Bluetooth network, the first node device broadcasts a second connectable undirected advertising packet.

### CROSS-REFERENCE TO RELATED APPLICATION

This application claims priority to China Application Serial Number 202210847146.4, filed Jul. 7, 2022, which is herein incorporated by reference in its entirety.

### BACKGROUND

### Field of Invention

The present invention relates to a Bluetooth network establishing system and method. More particularly, the present invention relates to a Bluetooth network establishing system and method for an environment of Bluetooth Low Energy (BLE).

### Description of Related Art

In the prior art, the Bluetooth low energy technology can support a point-to-point connection service between Bluetooth devices. However, before the operation of point-to-point connection, the Bluetooth devices need to be manually paired with each other, and only two Bluetooth devices can communicate with each other. Therefore, the prior art cannot automatically form a Bluetooth network with more Bluetooth devices.

In addition, in the prior art, a mesh network is proposed, which can perform network communication through a mechanism of an advertiser and a scanner. However, under such a mesh network mechanism, since the Bluetooth device as the scanner cannot determine the time point when the advertiser sends the data, it needs to be in the scanner mode most of the time, which makes the bandwidth utilization of the Bluetooth network low.

Accordingly, there is an urgent need for a technology that can automatically establish a Bluetooth network and improve the bandwidth utilization of the Bluetooth network.

### SUMMARY

An objective of the present disclosure is to provide a Bluetooth network establishing system. The Bluetooth network establishing system comprises a plurality of node devices and a gateway device. The gateway device is configured to connect a Bluetooth network to an external network and broadcast a first connectable undirected advertising packet. A first node device among the node devices executes a first scan operation to receive a first advertising packet, wherein the first advertising packet comprises the first connectable undirected advertising packet. The first node device determines whether to establish a first communication connection with the gateway device to join the Bluetooth network according to the first advertising packet. The first node device broadcasts a second connectable undirected advertising packet after joining the Bluetooth network.

Another objective of the present disclosure is to provide a Bluetooth network establishing method, which is adapted for use in a Bluetooth network establishing system. The Bluetooth network establishing system comprises a plurality of node devices and a gateway device. The gateway device is configured to connect a Bluetooth network to an external network and broadcast a first connectable undirected advertising packet. The Bluetooth network establishing method comprises following steps: broadcasting, by the gateway device, a first connectable undirected advertising packet; executing, by a first node device among the node devices, a first scan operation to receive a first advertising packet, wherein the first advertising packet comprises the first connectable undirected advertising packet; determining, by the first node device, whether to establish a first communication connection with the gateway device to join the Bluetooth network according to the first advertising packet; and broadcasting, by the first node device, a second connectable undirected advertising packet after joining the Bluetooth network.

According to the above descriptions, the Bluetooth network establishing technology (at least including the system and method) provided by the present disclosure broadcasts the connectable undirected advertising packet through gateway device and relay device, and the node device executes a scan operation and determines whether to establish a communication connection with the gateway device or relay device to join the Bluetooth network according to the advertising packet received by scanning. In addition, after the node device with the relay function joins the Bluetooth network, the node device broadcasts a connectable undirected advertising packet to continue to expand the range of the Bluetooth network. The Bluetooth network establishing technology provided by the present disclosure determines whether to establish a communication connection through the operation of advertising and scanning, so that a larger Bluetooth network can be automatically established. Furthermore, the Bluetooth network establishing technology provided by the present disclosure establishes a communication connection between the Bluetooth devices. Therefore, the disadvantage that the Bluetooth device needs to be in the scanner mode for a long time in the prior art is solved, so that the utilization rate of the bandwidth of the Bluetooth network is improved.

The detailed technology and preferred embodiments implemented for the subject disclosure are described in the following paragraphs accompanying the appended drawings for people skilled in this field to well appreciate the features of the claimed disclosure.

### BRIEF DESCRIPTION OF THE DRAWINGS

FIG. 1 is a schematic diagram depicting an applicable scenario of the Bluetooth network establishing system of the first embodiment;

FIG. 2 is a schematic diagram depicting a Bluetooth network;

FIG. 3 is a schematic diagram depicting a Bluetooth network;

FIG. 4 is a schematic diagram depicting a Bluetooth network;

FIG. 5 is a schematic diagram depicting a Bluetooth network;

FIG. 6 is a schematic diagram depicting a Bluetooth network;

FIG. 7 is a schematic diagram depicting a Bluetooth network;

FIG. 8 is a schematic diagram depicting a Bluetooth network; and

FIG. 9 is a partial flowchart depicting the Bluetooth network establishing method of the second embodiment.

### DETAILED DESCRIPTION

In the following description, a Bluetooth network establishing system and method according to the present disclosure will be explained with reference to embodiments thereof. However, these embodiments are not intended to limit the present disclosure to any environment, applications, or implementations described in these embodiments. Therefore, the description of these embodiments is only for purpose of illustration rather than to limit the present disclosure. It shall be appreciated that, in the following embodiments and the attached drawings, elements unrelated to the present disclosure are omitted from depiction. In addition, dimensions of individual elements and dimensional relationships among individual elements in the attached drawings are provided only for illustration but not to limit the scope of the present disclosure.

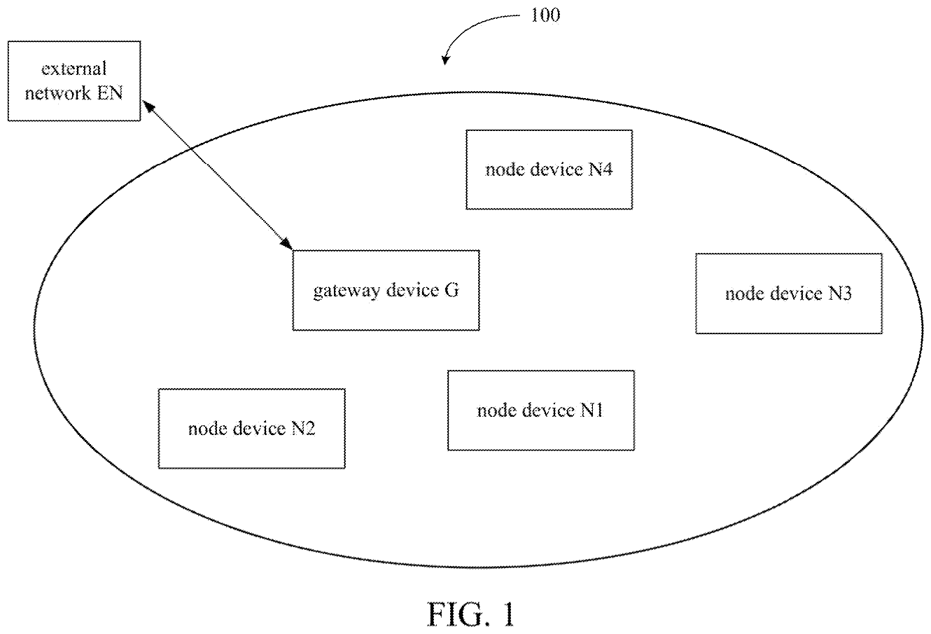

First, the applicable scenario of the Bluetooth network establishing system in the present disclosure will be described, and its schematic diagram is depicted in FIG. 1. FIG. 1 illustrates a Bluetooth network establishing system 100 that has not yet formed a complete Bluetooth network. In the present example, the Bluetooth network establishing system 100 comprises a plurality of node devices (e.g., node device N1, node device N2, node device N3, node device N4) and a gateway device G.

It shall be appreciated that FIG. 1 is only used as an example. The present disclosure does not limit the number of node devices in the Bluetooth network establishing system 100, and the number of node devices should be determined according to the scale and actual needs of the Bluetooth network establishing system 100.

In the present embodiment, as shown in FIG. 1, the gateway device G can be connected to an external network EN through a wired connection or a wireless connection. It shall be appreciated that the gateway device G is the external data access channel of the Bluetooth network. All data communication with the external network in the Bluetooth network needs to pass through the gateway device G (e.g., a routing device).

In the present embodiment, each of the node devices can be further subdivided into two types of devices, namely, a node device with a relay function (i.e., a relay device) and a node device without a relay function (i.e., a node device).

It shall be appreciated that in addition to the attributes of the node device, the relay device itself can also be used for the forwarding operation of data in the Bluetooth network (i.e., forwarding the received data), so each of the relay devices can act as the relay station of the node device or other relay device to transmit data to the gateway device. Furthermore, the node device without the relay function will not undertake the relay operation in the Bluetooth network, and will only receive and send data related to itself.

It shall be appreciated that, in the Bluetooth network, the gateway device G and the relay device have the capability of advertising. Moreover, the relay device and the node device have scanning capability. Those with ordinary knowledge in the art should be able to appreciate the operation of advertising and scanning, which will not be repeated here.

The first embodiment of the present disclosure will be described first, and please continue to refer to FIG. 1. In the first embodiment of the present disclosure, the gateway device G broadcasts a connectable undirected advertising packet (e.g., the first connectable undirected advertising packet).

Specifically, the gateway device G may broadcast the connectable undirected advertising packet based on different advertising mechanisms. For example, the gateway device G may broadcast the connectable undirected advertising packet according to an advertising interval parameter and an advertising window parameter. In some embodiments, the gateway device G broadcasts continuously or once every predetermined time interval.

It shall be appreciated that under the mechanism of the environment of Bluetooth Low Energy, a connectable undirected advertising packet is transmitted only during a point-to-point pairing connection. In addition, in a mesh network, data transmission is only executed by advertising undirected advertising packets, and no connection is performed (i.e., only unconnectable undirected advertising packets are transmitted for data transmission).

The present disclosure may form a larger Bluetooth network by establishing a communication connection between Bluetooth devices. Therefore, in the present disclosure, when establishing a Bluetooth network, the gateway device G and the relay device may send connectable undirected advertising packet to establish a communication connection.

Next, in the present embodiment, a first scan operation is executed by a first node device among the node devices to receive a first advertising packet, and the first advertising packet comprises the first connectable undirected advertising packet.

Specifically, the first node device may execute the scan operation based on different scan mechanisms. For example, the first node device may execute the first scan operation according to a scan interval parameter and a scan window parameter. In some embodiments, the first node device may scan continuously or once every predetermined time interval.

Subsequently, according to the first advertising packet, the first node device determines whether to establish a first communication connection with the gateway device G to join the Bluetooth network.

In the present embodiment, if the first node device is a relay device, after the first node device joins the Bluetooth network, the first node device further broadcasts a connectable undirected advertising packet (e.g., the second connectable undirected advertising packet).

Specifically, the first node device may broadcast the connectable undirected advertising packet based on different advertising mechanisms. For example, the first node device may broadcast the connectable undirected advertising packet according to an advertising interval parameter and an advertising window parameter. In some embodiments, the gateway device G may broadcast continuously or once every predetermined time interval.

In some embodiments, a second node device among the node devices further performs following operations: executing a second scan operation to receive a second advertising packet, wherein the second advertising packet comprises at least one of the first connectable undirected advertising packet and the second connectable undirected advertising packet; and determining whether to establish a second communication connection with the gateway device G or the first node device to join the Bluetooth network according to the second advertising packet.

In some embodiments, since the distance between the node device and the gateway device G may exceed the scanning range of the node device, the node device can only find other relay devices in the scanning range. In such a case, the node device can establish a communication connection with the relay device connected to the gateway device G. For example, the Bluetooth network currently comprises the gateway device G, the first node device, and a fourth node device among the node devices (i.e., a relay device that has established a communication connection). In some embodiments, the fourth node device broadcasts a third connectable undirected advertising packet, and a third node device among the node devices further performs following operations. The third node device executes a third scan operation to receive a third advertising packet, wherein the third advertising packet comprises the second connectable undirected advertising packet and the third connectable undirected advertising packet. The third node device determines whether to establish a third communication connection with the first node device or the fourth node device to join the Bluetooth network according to the third advertising packet.

In some embodiments, the connectable undirected advertising packets (e.g., the first connectable undirected advertising packet and the second connectable undirected advertising packet) comprise at least one of a network number, a device attribute flag and a path consumption or a combination thereof.

It shall be appreciated that the Bluetooth network can distinguish different local area networks (LANs) through different network numbers. For example, different LANs can be set with different network numbers to facilitate the control and identification of the device. In some embodiments, the Bluetooth network may not use the network number to distinguish, but only use the default network number (e.g., 0 or other reserved numbers).

It shall be appreciated that the purpose of the device attribute flag is to enable the packet receiver to determine whether the packet is a packet of the same Bluetooth network, so that the device can further execute subsequent processing after receiving. In addition, the device attribute flag can determine the attribute of the device sending the packet (e.g., the gateway device, the relay device, or the node device). In some embodiments, the device attribute flag can be implemented through information in different fields. For example, the device can be determined through fields such as Manufacturer Specific Data, Service Universally Unique Identifier, Service Data, and the like.

In some embodiments, the path consumption is related to one or a combination of a number of hops, a Bluetooth connection parameter, and a plurality of Bluetooth transmission quality influencing factors for transmitting the packet to the gateway device G. For example, when the device is directly connected to the gateway device G, the number of hops is 0. When the device is connected to the gateway device G through a relay device, the number of hops is 1. For another example, the Bluetooth connection parameter may be, for example, a connection interval, a connection window and the like in the Bluetooth connection. For another example, the plurality of Bluetooth transmission quality influencing factors may be the retransmission probability of data packets in the air, the modulation mode, the working mode (BLE 1M/BLE 2M), the available bandwidth of the device node, the congestion degree of the device node, etc.

In some embodiments, the node device can determine whether to join the Bluetooth network by comparing the network number. Specifically, the first node device compares whether the network number comprised in the first connectable undirected advertising packet is the same as the network number corresponding to the first node device. When the network number in the first connectable undirected advertising packet is the same as the network number corresponding to the first node device, the first node device establishes the first communication connection with the gateway device G to join the Bluetooth network.

In some embodiments, for the purpose of load balancing (e.g., transferring data though a plurality of paths simultaneously) or backup paths (e.g., when a path goes down, another backup path can still be used), the node device can also be connected to a plurality of devices with the same network number at the same time. Specifically, the second node device determines whether to establish the second communication connection with the gateway device G or the first node device to join the Bluetooth network by comparing whether the network number comprised in the first connectable undirected advertising packet and the second connectable undirected advertising packet is the same as the network number corresponding to the second node device. The second node device establishes the second communication connection with the gateway device G when the network number comprised in the first connectable undirected advertising packet is the same as the network number corresponding to the second node device. The second node device establishes the second communication connection with the first node device when the network number comprised in the second connectable undirected advertising packet is the same as the network number corresponding to the second node device.

In some embodiments, the node device can determine whether to join the Bluetooth network by calculating the path consumption of each device sending packets (e.g., the relay device and the gateway device G). Specifically, the second node device determines to establish the second communication connection with the gateway device G or the first node device according to the path consumption comprised in the first connectable undirected advertising packet and the second connectable undirected advertising packet. The path consumption is related to one or a combination of a number of hops, a Bluetooth connection parameter, and a plurality of Bluetooth transmission quality influencing factors for transmitting a packet to the gateway device G.

In some embodiments, the node device may establish a communication connection with a device with lower path consumption preferentially.

In some embodiments, the gateway device G and the relay device may further set the advertising interval parameter and the advertising window parameter of the advertiser mode to broadcast packets in the advertiser mode. Specifically, the gateway device G and the relay device further perform following operations: switching to an advertiser mode; and broadcasting the first connectable undirected advertising packet according to an advertising interval parameter and an advertising window parameter.

In some embodiments, the relay device and the node device may further set a scan interval parameter and a scan window parameter of the scanner mode to scan in the scanner mode. Specifically, the relay device and the node device further perform following operations: switching to a scanner mode; and executing the first scan operation according to a scan interval parameter and a scan window parameter.

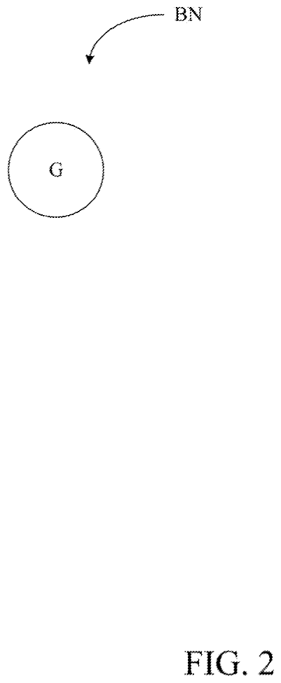

For ease of understanding, an actual process of establishing a Bluetooth network is used as an example to illustrate, please refer to FIG. 2 to FIG. 8 in sequence. In the present example, as shown in FIG. 2, the gateway device G starts to broadcast a connectable undirected advertising packet. Currently, the Bluetooth network BN only comprises the gateway device G.

For ease of understanding, the following node devices with a relay function will be directly referred to as relay devices. It shall be appreciated that a node device with a relay function is still a node device.

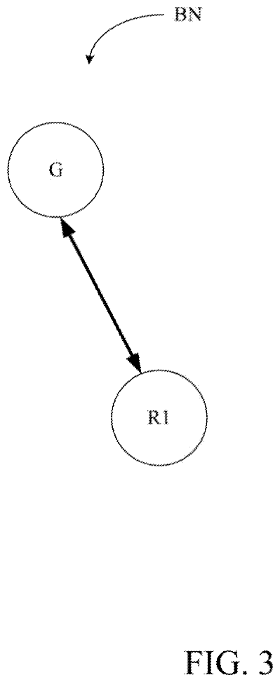

Next, in the present example, the relay device R1 starts to execute a scan operation to scan a nearby area (e.g., a range area centered on the relay device R1) whether there is a packet sent by the gateway device G or other relay devices. Then, as shown in FIG. 3, since the relay device R1 scans the connectable undirected advertising packet of the gateway device G, the relay device R1 establishes a communication connection with the gateway device G and joins the Bluetooth network BN. In addition, after the relay device R1 is successfully connected to the gateway device G, the relay device R1 may notify (i.e., broadcasting a connectable undirected advertising packet) other devices that it is already a relay device.

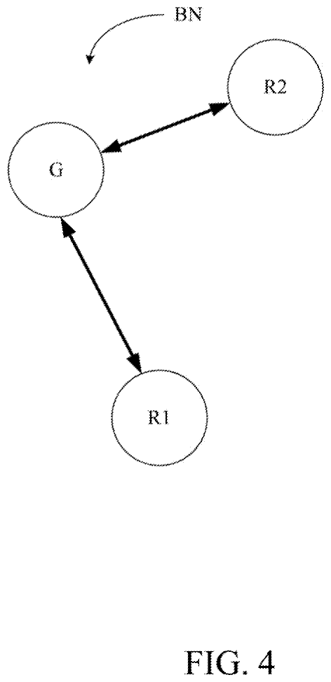

Next, in the present example, the relay device R2 starts to execute a scan operation to scan whether there is a packet sent by the gateway device G or other relay devices in the nearby area. In the present example, the relay device R2 scans the connectable undirected advertising packets broadcasted by the gateway device G and the relay device R1 respectively. Then, as shown in FIG. 4, the relay device R2 chooses to establish a communication connection with the gateway device G (e.g., the relay device R2 can make a determination based on an algorithm, for example, based on the network number, path consumption, load balancing, backup paths, etc.), and join to the Bluetooth network BN. In addition, after the relay device R2 is successfully connected to the gateway device G, the relay device R2 may notify (i.e., broadcasting a connectable undirected advertising packet) other devices that it is already a relay device.

In some examples, the relay device R2 can also establish communication connections with both the gateway device G and the relay device R1.

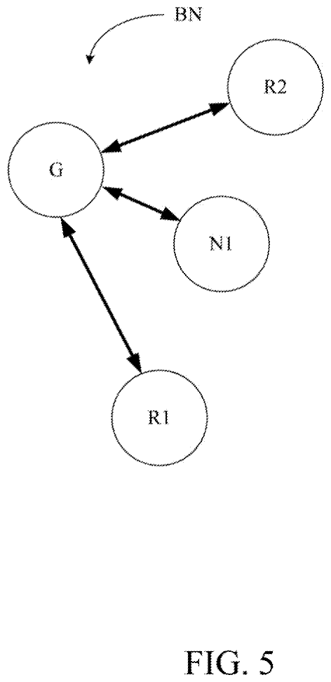

Next, in the present example, the node device N1 starts to execute a scan operation to scan a nearby area whether there is a packet sent by the gateway device G or other relay devices. In the present example, the node device N1 scans the connectable undirected advertising packets broadcasted by the gateway device G, the relay device R1, and the relay device R2 respectively. Then, as shown in FIG. 5, the node device N1 chooses to establish a communication connection with the gateway device G (e.g., the node device N1 can make a determination based on an algorithm, for example, based on the network number, path consumption, load balancing, backup path, etc.), and join to the Bluetooth network BN. In addition, since the node device N1 is only a node device and does not have a relay function, the node device N1 will not send advertising packets to other devices.

In some examples, the node device N1 can also establish a communication connection with any one, both or all of the gateway device G, the relay device R1, and the relay device R2.

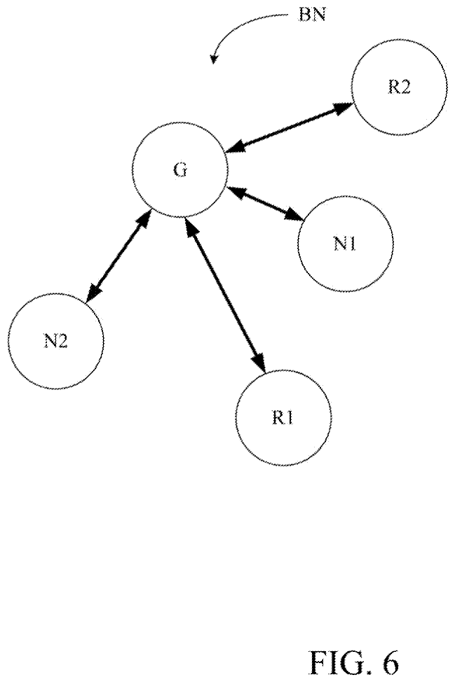

Next, in the present example, the node device N2 starts to execute a scan operation to scan whether there is a packet sent by the gateway device G or other relay devices in the nearby area. In the present example, due to the distance relationship (i.e., the relay device R2 is too far away to be in the scanning range), the node device N2 only scans the connectable undirected advertising packets broadcasted by the gateway device G and the relay device R1. Then, as shown in FIG. 6, the node device N1 chooses to establish a communication connection with the gateway device G (e.g., the node device N2 can make a determination based on an algorithm, for example: based on the network number, path consumption, load balancing, backup path, etc.), and join to the Bluetooth network BN. In addition, since the node device N2 is only a node device and does not have a relay function, the node device N2 will not send advertising packets to other devices.

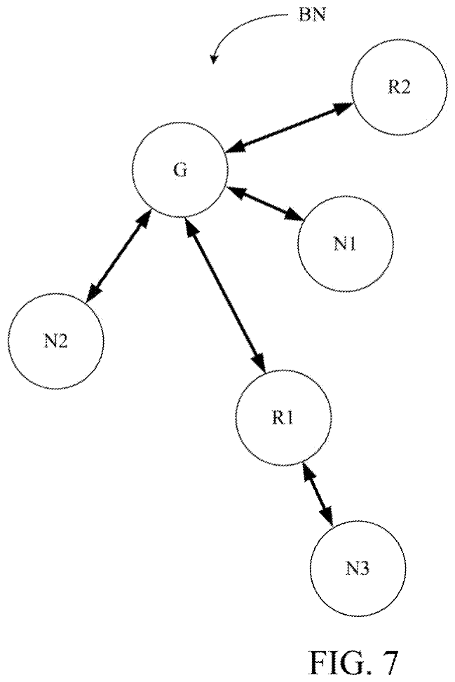

Next, in the present example, the node device N3 starts to execute a scan operation to scan whether there is a packet sent by the gateway device G or other relay devices. In the present example, due to the distance relationship (i.e., the gateway device G and the relay device R2 are too far away to be in the scanning range), the node device N3 only scans the connectable undirected advertising packet broadcasted by the relay device R1. Then, as shown in FIG. 7, the node device N3 chooses to establish a communication connection with the relay device R1 and joins to the Bluetooth network BN. In addition, since the node device N3 is only a node device and does not have a relay function, the node device N3 will not send advertising packets to other devices.

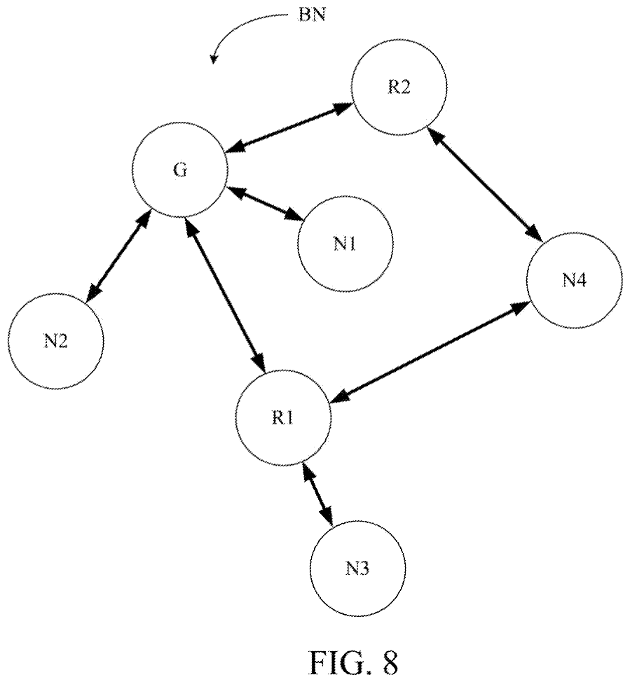

Next, in the present example, the node device N4 starts to execute a scan operation to scan whether there is a packet sent by the gateway device G or other relay devices in the nearby area. In the present example, due to the distance relationship (i.e., the gateway device G is too far away to be in the scanning range), the node device N4 only scans the connectable undirected advertising packets broadcasted by the relay device R1 and the relay device R2. Then, as shown in FIG. 8, the node device N4 chooses to establish the communication connections with both the relay device R1 and the relay device R2, and joins to the Bluetooth network BN. In addition, since the node device N4 is only a node device and does not have a relay function, the node device N4 will not send advertising packets to other devices.

In the present example, as shown in FIG. 8, the Bluetooth network BN has been established. The Bluetooth network BN comprises a gateway device G, the relay device R1, the relay device R2, the node devices N1, N2, N3, N4 and their respective communication connection relationships.

According to the above descriptions, the Bluetooth network establishing system 100 provided by the present disclosure broadcasts the connectable undirected advertising packet through gateway device and relay device, and the node device executes a scan operation and determines whether to establish a communication connection with the gateway device or relay device to join the Bluetooth network according to the advertising packet received by scanning. In addition, after the node device with the relay function joins the Bluetooth network, the node device broadcasts a connectable undirected advertising packet to continue to expand the range of the Bluetooth network. The Bluetooth network establishing system 100 provided by the present disclosure determines whether to establish a communication connection through the operation of advertising and scanning, so that a larger Bluetooth network can be automatically established. Furthermore, the Bluetooth network establishing system 100 provided by the present disclosure establishes a communication connection between the Bluetooth devices. Therefore, the disadvantage that the Bluetooth device needs to be in the scanner mode for a long time in the prior art is solved, so that the utilization rate of the bandwidth of the Bluetooth network is improved.

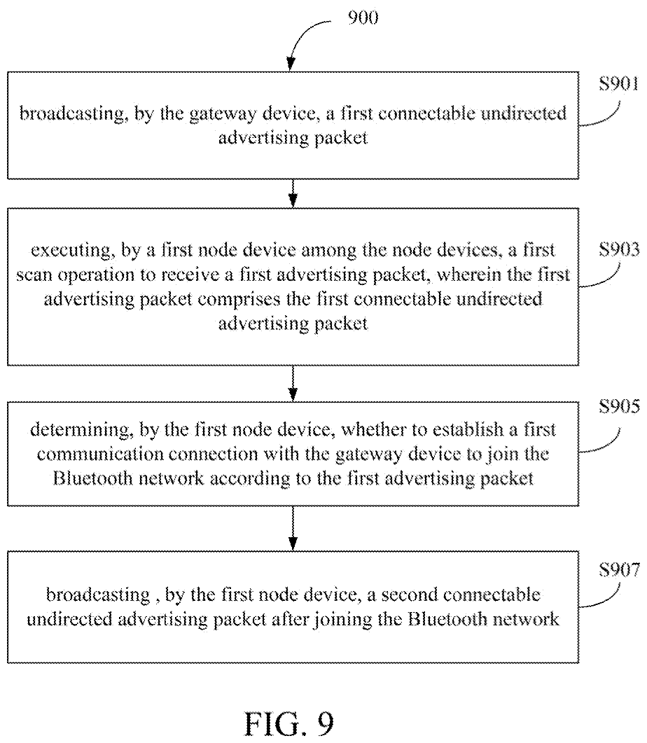

A second embodiment of the present disclosure is a Bluetooth network establishing method and a flowchart thereof is depicted in FIG. 9. The Bluetooth network establishing method 900 is adapted for a Bluetooth network establishing system (e.g., the Bluetooth network establishing system 100 of the first embodiment). The Bluetooth network establishing system comprises a plurality of node devices and a gateway device (e.g., the node devices N1, N2, N3, N4 and the gateway device G of the first embodiment). The gateway device is configured to connect a Bluetooth network to an external network. The Bluetooth network establishing method 900 establishes the Bluetooth network through steps S901 to S907.

In the step S901, the gateway device broadcasts a first connectable undirected advertising packet. Next, in the step S903, a first node device among the node devices executes a first scan operation to receive a first advertising packet, wherein the first advertising packet comprises the first connectable undirected advertising packet.

Next, in the step S905, the first node device determines whether to establish a first communication connection with the gateway device to join the Bluetooth network according to the first advertising packet. Finally, in the step S907, after joining the Bluetooth network, the first node device broadcasts a second connectable undirected advertising packet.

In some embodiments, the Bluetooth network establishing method 900 further comprises following steps: executing, by a second node device among the node devices, a second scan operation to receive a second advertising packet, wherein the second advertising packet comprises at least one of the first connectable undirected advertising packet and the second connectable undirected advertising packet; and determining, by the second node device, whether to establish a second communication connection with the gateway device or the first node device to join the Bluetooth network according to the second advertising packet.

In some embodiments, wherein the Bluetooth network comprises the gateway device, the first node device, and a fourth node device among the node devices, and the Bluetooth network establishing method 900 further comprises following steps: broadcasting, by the fourth node device, a third connectable undirected advertising packet; executing, by a third node device among the node devices, a third scan operation to receive a third advertising packet, wherein the third advertising packet comprises the second connectable undirected advertising packet and the third connectable undirected advertising packet; and determining, by the third node device, whether to establish a third communication connection with the first node device or the fourth node device to join the Bluetooth network according to the third advertising packet.

In some embodiments, the first connectable undirected advertising packet and the second connectable undirected advertising packet comprise at least one of a network number, a device attribute flag and a path consumption or a combination thereof.

In some embodiments, the Bluetooth network establishing method 900 further comprises following steps: comparing, by the first node device, whether the network number comprised in the first connectable undirected advertising packet is the same as the network number corresponding to the first node device; and establishing the first communication connection with the gateway device to join the Bluetooth network when the network number in the first connectable undirected advertising packet is the same as the network number corresponding to the first node device.

In some embodiments, the Bluetooth network establishing method 900 further comprises following steps: determining, by the second node device, whether to establish the second communication connection with the gateway device or the first node device to join the Bluetooth network by comparing whether the network number comprised in the first connectable undirected advertising packet and the second connectable undirected advertising packet is the same as the network number corresponding to the second node device; wherein the second node device establishes the second communication connection with the gateway device when the network number comprised in the first connectable undirected advertising packet is the same as the network number corresponding to the second node device; wherein the second node device establishes the second communication connection with the first node device when the network number comprised in the second connectable undirected advertising packet is the same as the network number corresponding to the second node device.

In some embodiments, the Bluetooth network establishing method 900 further comprises following steps: determining, by the second node device, to establish the second communication connection with the gateway device or the first node device according to the path consumption comprised in the first connectable undirected advertising packet and the second connectable undirected advertising packet; wherein the path consumption is related to one or a combination of a number of hops, a Bluetooth connection parameter, and a plurality of Bluetooth transmission quality influencing factors for transmitting a packet to the gateway device.

In some embodiments, the Bluetooth network establishing method 900 further comprises following steps: switching, by the gateway device, to an advertiser mode; and broadcasting, by the gateway device, the first connectable undirected advertising packet according to an advertising interval parameter and an advertising window parameter.

In some embodiments, the Bluetooth network establishing method 900 further comprises following steps: switching, by the first node device, to a scanner mode; and executing, by the first node device, the first scan operation according to a scan interval parameter and a scan window parameter.

In some embodiments, the Bluetooth network establishing method 900 further comprises following steps: switching, by the first node device, to an advertiser mode; and broadcasting, by the first node device, the second connectable undirected advertising packet according to an advertising interval parameter and an advertising window parameter.

In addition to the aforesaid steps, the second embodiment can also execute all the operations and steps of the Bluetooth network establishing system 100 set forth in the first embodiment, have the same functions, and deliver the same technical effects as the first embodiment. How the second embodiment executes these operations and steps, has the same functions, and delivers the same technical effects will be readily appreciated by those of ordinary skill in the art based on the explanation of the first embodiment. Therefore, the details will not be repeated herein.

It shall be appreciated that in the specification and the claims of the present disclosure, some words (e.g., the connectable undirected advertising packet, the node device, the scan operation, the advertising packet, and the communication connection, etc.) are preceded by terms such as “first”, “second”, “third”, and “fourth”, and these terms of “first”, “second”, “third”, and “fourth” are only used to distinguish these different words. For example, the “third” and “fourth” of the third node device and the fourth node device are only used to indicate the node device used in different operations.

According to the above descriptions, the Bluetooth network establishing technology (at least including the system and method) provided by the present disclosure broadcasts the connectable undirected advertising packet through gateway device and relay device, and the node device executes a scan operation and determines whether to establish a communication connection with the gateway device or relay device to join the Bluetooth network according to the advertising packet received by scanning. In addition, after the node device with the relay function joins the Bluetooth network, the node device broadcasts a connectable undirected advertising packet to continue to expand the range of the Bluetooth network. The Bluetooth network establishing technology provided by the present disclosure determines whether to establish a communication connection through the operation of advertising and scanning, so that a larger Bluetooth network can be automatically established. Furthermore, the Bluetooth network establishing technology provided by the present disclosure establishes a communication connection between the Bluetooth devices. Therefore, the disadvantage that the Bluetooth device needs to be in the scanner mode for a long time in the prior art is solved, so that the utilization rate of the bandwidth of the Bluetooth network is improved.

The above disclosure is related to the detailed technical contents and inventive features thereof. People skilled in this field may proceed with a variety of modifications and replacements based on the disclosures and suggestions of the disclosure as described without departing from the characteristics thereof. Nevertheless, although such modifications and replacements are not fully disclosed in the above descriptions, they have substantially been covered in the following claims as appended.

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A Bluetooth network establishing system, comprising:
a plurality of node devices; and
a gateway device, being configured to connect a Bluetooth network to an external network and broadcast a first connectable undirected advertising packet;
wherein, a first node device among the node devices performs following operations:
executing a first scan operation to receive a first advertising packet, wherein the first advertising packet comprises the first connectable undirected advertising packet;
determining whether to establish a first communication connection with the gateway device to join the Bluetooth network according to the first advertising packet; and
broadcasting a second connectable undirected advertising packet after joining the Bluetooth network.

2. The Bluetooth network establishing system of claim 1, wherein a second node device among the node devices performs following operations:
executing a second scan operation to receive a second advertising packet, wherein the second advertising packet comprises at least one of the first connectable undirected advertising packet and the second connectable undirected advertising packet; and
determining whether to establish a second communication connection with the gateway device or the first node device to join the Bluetooth network according to the second advertising packet.

3. The Bluetooth network establishing system of claim 2, wherein the Bluetooth network comprises the gateway device, the first node device, and a fourth node device among the node devices, the fourth node device broadcasts a third connectable undirected advertising packet, and a third node device among the node devices performs following operations:
executing a third scan operation to receive a third advertising packet, wherein the third advertising packet comprises the second connectable undirected advertising packet and the third connectable undirected advertising packet; and
determining whether to establish a third communication connection with the first node device or the fourth node device to join the Bluetooth network according to the third advertising packet.

4. The Bluetooth network establishing system of claim 2, wherein the first connectable undirected advertising packet and the second connectable undirected advertising packet comprise at least one of a network number, a device attribute flag, and a path consumption or a combination thereof.

5. The Bluetooth network establishing system of claim 4, wherein the first node device further performs following operations:
comparing whether the network number comprised in the first connectable undirected advertising packet is the same as the network number corresponding to the first node device; and
establishing the first communication connection with the gateway device to join the Bluetooth network when the network number in the first connectable undirected advertising packet is the same as the network number corresponding to the first node device.

6. The Bluetooth network establishing system of claim 4, wherein the second node device further performs following operations:
determining whether to establish the second communication connection with the gateway device or the first node device to join the Bluetooth network by comparing whether the network number comprised in the first connectable undirected advertising packet and the second connectable undirected advertising packet is the same as the network number corresponding to the second node device;
wherein the second node device establishes the second communication connection with the gateway device when the network number comprised in the first connectable undirected advertising packet is the same as the network number corresponding to the second node device;
wherein the second node device establishes the second communication connection with the first node device when the network number comprised in the second connectable undirected advertising packet is the same as the network number corresponding to the second node device.

7. The Bluetooth network establishing system of claim 4, wherein the second node device further performs following operations:
determining to establish the second communication connection with the gateway device or the first node device according to the path consumption comprised in the first connectable undirected advertising packet and the second connectable undirected advertising packet;
wherein the path consumption is related to one or a combination of a number of hops, a Bluetooth connection parameter, and a plurality of Bluetooth transmission quality influencing factors for transmitting a packet to the gateway device.

8. The Bluetooth network establishing system of claim 1, wherein the gateway device further performs following operations:
switching to an advertiser mode; and
broadcasting the first connectable undirected advertising packet according to an advertising interval parameter and an advertising window parameter.

9. The Bluetooth network establishing system of claim 1, wherein the first node device further performs following operations:
switching to a scanner mode; and
executing the first scan operation according to a scan interval parameter and a scan window parameter.

10. The Bluetooth network establishing system of claim 1, wherein the first node device further performs following operations:
switching to an advertiser mode; and
broadcasting the second connectable undirected advertising packet according to an advertising interval parameter and an advertising window parameter.

11. A Bluetooth network establishing method, being adapted for use in a Bluetooth network establishing system, wherein the Bluetooth network establishing system comprises a plurality of node devices and a gateway device, the gateway device is configured to connect a Bluetooth network to an external network, and the Bluetooth network establishing method comprises following steps:
broadcasting, by the gateway device, a first connectable undirected advertising packet;
executing, by a first node device among the node devices, a first scan operation to receive a first advertising packet, wherein the first advertising packet comprises the first connectable undirected advertising packet;
determining, by the first node device, whether to establish a first communication connection with the gateway device to join the Bluetooth network according to the first advertising packet; and
broadcasting, by the first node device, a second connectable undirected advertising packet after joining the Bluetooth network.

12. The Bluetooth network establishing method of claim 11, wherein the Bluetooth network establishing method further comprises following steps:
executing, by a second node device among the node devices, a second scan operation to receive a second advertising packet, wherein the second advertising packet comprises at least one of the first connectable undirected advertising packet and the second connectable undirected advertising packet; and
determining, by the second node device, whether to establish a second communication connection with the gateway device or the first node device to join the Bluetooth network according to the second advertising packet.

13. The Bluetooth network establishing method of claim 12, wherein the Bluetooth network comprises the gateway device, the first node device, and a fourth node device among the node devices, and the Bluetooth network establishing method further comprises following steps:
broadcasting, by the fourth node device, a third connectable undirected advertising packet;
executing, by a third node device among the node devices, a third scan operation to receive a third advertising packet, wherein the third advertising packet comprises the second connectable undirected advertising packet and the third connectable undirected advertising packet; and
determining, by the third node device, whether to establish a third communication connection with the first node device or the fourth node device to join the Bluetooth network according to the third advertising packet.

14. The Bluetooth network establishing method of claim 12, wherein the first connectable undirected advertising packet and the second connectable undirected advertising packet comprise at least one of a network number, a device attribute flag, and a path consumption or a combination thereof.

15. The Bluetooth network establishing method of claim 14, wherein the Bluetooth network establishing method further comprises following steps:
comparing, by the first node device, whether the network number comprised in the first connectable undirected advertising packet is the same as the network number corresponding to the first node device; and
establishing the first communication connection with the gateway device to join the Bluetooth network when the network number in the first connectable undirected advertising packet is the same as the network number corresponding to the first node device.

16. The Bluetooth network establishing method of claim 14, wherein the Bluetooth network establishing method further comprises following steps:
determining, by the second node device, whether to establish the second communication connection with the gateway device or the first node device to join the Bluetooth network by comparing whether the network number comprised in the first connectable undirected advertising packet and the second connectable undirected advertising packet is the same as the network number corresponding to the second node device;
wherein the second node device establishes the second communication connection with the gateway device when the network number comprised in the first connectable undirected advertising packet is the same as the network number corresponding to the second node device;
wherein the second node device establishes the second communication connection with the first node device when the network number comprised in the second connectable undirected advertising packet is the same as the network number corresponding to the second node device.

17. The Bluetooth network establishing method of claim 14, wherein the Bluetooth network establishing method further comprises following steps:
determining, by the second node device, to establish the second communication connection with the gateway device or the first node device according to the path consumption comprised in the first connectable undirected advertising packet and the second connectable undirected advertising packet;
wherein the path consumption is related to one or a combination of a number of hops, a Bluetooth connection parameter, and a plurality of Bluetooth transmission quality influencing factors for transmitting a packet to the gateway device.

18. The Bluetooth network establishing method of claim 11, wherein the Bluetooth network establishing method further comprises following steps:
switching, by the gateway device, to an advertiser mode; and
broadcasting, by the gateway device, the first connectable undirected advertising packet according to an advertising interval parameter and an advertising window parameter.

19. The Bluetooth network establishing method of claim 11, wherein the Bluetooth network establishing method further comprises following steps:
switching, by the first node device, to a scanner mode; and
executing, by the first node device, the first scan operation according to a scan interval parameter and a scan window parameter.

20. The Bluetooth network establishing method of claim 11, wherein the Bluetooth network establishing method further comprises following steps:
switching, by the first node device, to an advertiser mode; and
broadcasting, by the first node device, the second connectable undirected advertising packet according to an advertising interval parameter and an advertising window parameter.
